(19) United States
(12) Patent Application Publication
(10) Pub. No.: US 2011/0229629 A1
(43) Pub. Date: Sep. 22, 2011

(54) METHOD FOR PRODUCING LIQUID CRYSTALLINE POLYESTER IMPREGNATED FIBER SHEET

(75) Inventors: Toyonari ITO, Tsukuba-shi (JP); Shohei AZAMI, Tsukuba-shi (JP)

(73) Assignee: SUMITOMO CHEMICAL COMPANY, LIMITED, Tokyo (JP)

(21) Appl. No.: 13/049,045

(22) Filed: Mar. 16, 2011

(30) Foreign Application Priority Data
Mar. 16, 2010 (JP) P2010-058956
Mar. 16, 2010 (JP) P2010-058957

(51) Int. Cl. B05D 5/12; B29C 70/36

(52) U.S. Cl. 427/58; 264/136

(57) ABSTRACT

A method for producing a liquid crystalline polyester impregnated fiber sheet, comprising a step of impregnating a fiber sheet composed of an aramid fiber or a polybenzazole fiber with a liquid composition containing a liquid crystalline polyester and an aprotic solvent free of a halogen atom and a step of removing the solvent from the fiber sheet impregnated with the liquid composition. As the above mentioned solvent, N,N-dimethylformamide, N,N-dimethylacetamide and N-methylpyrrolidone are preferably used. As the above mentioned sheet, textiles are preferably used.

### BACKGROUND OF THE INVENTION

1. Field of the Invention

The present invention relates to a method for producing a liquid crystalline polyester impregnated fiber sheet prepared by impregnating a fiber sheet with a liquid crystalline polyester.

2. Related Background Art

As a resin impregnated fiber sheet used for an insulating layer of a printed circuit board, an epoxy resin impregnated fiber sheet prepared by impregnating a fiber sheet with an epoxy resin and curing the sheet has long been known, but problems of such a sheet are that the sheet has a low heat resistance likely causing deformation and blister at the time of element mounting by soldering and that the sheet has a high dielectric loss making it difficult to be compatible with higher frequency digital signals. Recently, as a resin impregnated fiber sheet having good heat resistance and low dielectric loss, a liquid crystalline polyester impregnated fiber sheet prepared by impregnating a fiber sheet with liquid crystalline polyester has been proposed, and as a method for producing such a sheet, a method wherein a fiber sheet is impregnated with a liquid composition containing liquid crystalline polyester and a solvent followed by removing the solvent has been studied. For example, in Patent Document 1 (Japanese Patent Application Laid-Open No. 2004-244621) a method wherein a halogen-substituted phenol compound is used as the solvent, a sheet composed of a glass fiber, carbon fiber, ceramics fiber, polyester fiber or aramid fiber is used as the fiber sheet is described and in Patent Document 2 (Japanese Patent Application Laid-Open No. 2005-194406) a method wherein a halogen-substituted phenol is used as the solvent and a sheet composed of a liquid crystalline polyester fiber is used as the fiber sheet is described. Further, in Patent Document 3 (Japanese Patent Application Laid-Open No. 2006-1959), a method wherein an aprotic solvent free of a halogen atom is used as the solvent and a sheet composed of an inorganic fiber or a carbon fiber is used as the fiber sheet is described, and in Patent Document 4 (Japanese Patent Application Laid-Open No. 2007-146139), a method wherein an aprotic solvent is used as the solvent and a sheet composed of a liquid crystalline polyester fiber is used as the fiber sheet is described.

### SUMMARY OF THE INVENTION

The liquid crystalline polyester impregnated fiber sheets obtained by the methods described in Patent Documents 1 to 4 are required to be further improved in dimensional stability in view of the fact that the printed circuit boards have been made thinner and smaller and have had higher density element mounting in recent years. Under these circumstances, an object of the present invention is to provide a method capable of producing a liquid crystalline polyester impregnated fiber sheet having good dimensional stability.

In order to accomplish the above object, the present invention provides a method for producing a liquid crystalline polyester impregnated fiber sheet comprising a step of impregnating a fiber sheet composed of an aramid fiber or a polybenzazole fiber with a liquid composition containing a liquid crystalline polyester and an aprotic solvent free of a halogen atom, and a step of removing the solvent from the fiber sheet impregnated with the liquid composition. Further, according to the present invention, another method is also provided for producing a conductive layer attached liquid crystalline polyester impregnated fiber sheet comprising a step of obtaining a liquid crystalline polyester impregnated fiber sheet by the method described above and a step of forming a conductor layer on at least one of the surfaces of the liquid crystalline polyester impregnated fiber sheet.

According to the present invention, a liquid crystalline polyester impregnated fiber sheet having good dimensional stability can be produced.

### DESCRIPTION OF THE PREFERRED EMBODIMENTS

It is preferable that the liquid crystalline polyester used in the present invention be a polyester which exhibits optical anisotropy when melted, form an anisotropy melt at a temperature of 450° C. or lower, and have a structural unit represented by formula (1) (hereinafter sometimes referred to as “structural unit (1)”), a structural unit represented by formula (2) (hereinafter sometimes referred to as “structural unit (2)”) and a structural unit represented by formula (3) (hereinafter sometimes referred to as “structural unit (3)”).

(1) —O-Ar¹-CO—

(2) —CO-Ar²-CO—

(3) —X-Ar³-Y—

wherein Ar¹ represents a phenylene group or a naphthylene group, Ar² represents a phenylene group, a naphthylene group or a group represented by formula (4), Ar³ represents a phenylene group or a group represented by formula (4), X and Y, each independently, represent O or NH, and hydrogen atom(s) in the group represented by Ar¹, Ar² or Ar³, each independently, are optionally substituted with a halogen atom, an alkyl group or an aryl group.

(4) —Ar⁴-Z-Ar⁵—

wherein Ar⁴ and Ar⁵, each independently, represent a phenylene group or a naphthylene group, and Z represents O, CO or SO₂.

The structural unit (1) is a structural unit derived from aromatic hydroxycarboxylic acid, and examples of the aromatic hydroxycarboxylic acid include p-hydroxybenzoic acid, m-hydroxybenzoic acid, 2-hydroxy-6-naphthoic acid, 2-hydroxy-3-naphthoic acid and 1-hydroxy-4-naphthoic acid.

The structural unit (2) is a structural unit derived from aromatic dicarboxylic acid, and examples of the aromatic dicarboxylic acid include terephthalic acid, isophthalic acid, 2,6-naphthalene dicarboxylic acid, 1,5-naphthalene dicarboxylic acid, diphenyl ether-4,4′-dicarboxylic acid, diphenylsulfone 4,4′-dicarboxylic acid and diphenyl ketone 4,4′-dicarboxylic acid.

The structural unit (3) is a structural unit derived from aromatic diol, aromatic hydroxyamine or aromatic diamine, and examples of the aromatic diol include hydroquinone, resorcin, 2,2-bis(4-hydroxy-3,5-dimethylphenyl)propane, bis(4-hydroxyphenyl)ether, bis(4-hydroxyphenyl)ketone and bis(4-hydroxyphenyl)sulfone, examples of the aromatic hydroxyamine include p-aminophenol and m-aminophenol, and examples of the aromatic diamine include 1,4-phenylenediamine and 1,3-phenylenediamine.

The content of the structural unit (1) is preferably 30 to 60 mol%, more preferably 30 to 50 mol%, further preferably 30 to 45 mol% and still preferably 35 to 40 mol%, based on the total amount of all structural units composing the liquid crystalline polyester. As the content of the structural unit (1) increases, the liquid crystalline properties of the liquid crystalline polyester tend to be improved, and as the content of the structural unit (1) decreases, the solubility of the liquid crystalline polyester in a solvent tends to be improved.

The content of the structural unit (2) is preferably 20 to 35 mol%, more preferably 25 to 35 mol%, further preferably 27.5 to 35 mol% and still preferably 30 to 32.5 mol%, based on the total amount of all structural units composing the liquid crystalline polyester. As the content of the structural unit (2) increases, the solubility of the liquid crystalline polyester in a solvent tends to be improved, and as the content of the structural unit (2) decreases, the liquid crystalline properties of the liquid crystalline polyester tends to be improved.

The content of the structural unit (3) is preferably 20 to 35 mol%, more preferably 25 to 35 mol%, further preferably 27.5 to 35 mol% and still preferably 30 to 32.5 mol%, based on the total amount of all structural units composing the liquid crystalline polyester. As the content of the structural unit (3) increases, the solubility of the liquid crystalline polyester in a solvent tends to be improved, and as the content of the structural unit (3) decreases, the liquid crystalline properties of the liquid crystalline polyester tends to be improved.

Further, the content ratio of the structural unit (2) to the structural unit (3) is preferably 0.9/1 to 1/0.9 when expressed in [structural unit (2)]/[structural unit (3)] (mol/mol) since the liquid crystalline polyester expresses high liquid crystalline properties.

Furthermore, it is preferable that the liquid crystalline polyester have the structural unit (3) wherein X and/or Y is NH, specifically, have a structural unit derived from aromatic hydroxyamine and/or a structural unit derived from aromatic diamine due to good solubility in a solvent and low water absorbency, and it is more preferable that substantially all X and/or Y in the structural unit (3) be NH.

When considering the availability of ingredient monomers in addition to the liquid crystalline properties, the solubility in a solvent and low water absorbency, it is preferable that the liquid crystalline polyester have the structural unit (1) wherein Ar¹ is a 1,4-phenylene group (a structural unit derived from p-hydroxybenzoic acid) and/or Ar¹ is a 2,6-naphthylene group (a structural unit derived from 2-hydroxy-6-naphthoic acid), at least one structural unit (2) selected from the group consisting of wherein Ar² is a 1,4-phenylene group (a structural unit derived from terephthalic acid), Ar² is a 1,3-phenylene group (a structural unit derived from isophthalic acid) and Ar² is a 2,6-naphthylene group (a structural unit derived from 2,6-naphthalene dicarboxylic acid), and the structural unit (3) wherein Ar³ is a 1,4-phenylene group, X is O and Y is NH (a structural unit derived from p-aminophenol).

The liquid polyester can be produced by various known methods. For example, when producing the liquid crystalline polyester having a structural unit derived from aromatic hydroxycarboxylic acid such as the structural unit (1), a structural unit derived from aromatic dicarboxylic acid such as the structural unit (2) and a structural unit derived from aromatic diol, aromatic hydroxyamine or aromatic diamine such as the structural unit (3), a method for producing a liquid crystalline polyester wherein a monomer capable of inducing each of these structural units is converted to an ester forming derivative or an amide forming derivative (hereinafter sometimes referred together to as “ester/amide forming derivative”) followed by polymerization is easily operable, hence preferable.

Examples of the ester/amide forming derivative of a monomer having a carboxyl group such as aromatic hydroxycarboxylic acid and aromatic dicarboxylic acid include those wherein a carboxyl group is present in the form of a highly reactive group such as a haloformyl group, an acyloxy carbonyl group, etc., forming acid chloride, acid anhydride, etc., so that the polyester or polyamide production reaction is facilitated and those wherein a carboxyl group forms ester with alcohols, ethylene glycol, etc., so that polyester or polyamide is produced by ester exchange or amide exchange (hereinafter sometimes referred together to as “ester/amide exchange”).

Examples of the ester/amide forming derivative of a monomer having a phenolic hydroxyl group such as aromatic hydroxycarboxylic acid, aromatic diol and aromatic hydroxyamine include those wherein a phenolic hydroxyl group forms ester with carboxylic acids so that polyester or polyamide is produced by ester/amide exchange.

Further, examples of the amide forming derivative of a monomer having an amino group such as aromatic hydroxyamine and aromatic diamine include those wherein an amino group forms amide with carboxylic acids so that polyamide is produced by amide exchange.

Among these, to produce liquid crystalline polyester in an easier manner, a method for producing liquid crystalline polyester wherein a monomer having a phenolic hydroxyl group and/or an amino group such as aromatic hydroxycarboxylic acid, aromatic diol, aromatic hydroxyamine, aromatic diamine is acylated with a fatty acid anhydride to form an acylated product being an ester/amide forming derivative and the acylated product and the monomer having a carboxyl group are polymerized by ester/amide exchange so that the acyl group of the acylated product is exchanged with the acyl group equivalent to the residue prepared by removing the hydroxyl group from the carboxyl group of the monomer having the carboxyl group is particularly preferable. Such a method for producing liquid crystalline polyester is described in, for example, Japanese Patent Application Laid-Open No. 2002-220444 and Japanese Patent Application Laid-Open No. 2002-146003.

In the acylation, it is preferable for the amount of the fatty acid anhydride used to be 1.0 to 1.2 times by mole, and it is more preferable to be 1.05 to 1.1 times by mole, based on the total of a phenolic hydroxyl group and an amino group. When the amount of the fatty acid anhydride used is too small, the acylated product and ingredient monomers are sublimated during the polymerization likely causing the reaction system to close, whereas when the amount is too large, the obtained liquid crystalline polyester is likely to be colored.

It is preferable to carry out the acylation at 130 to 180° C. for 5 minutes to 10 hours, and it is more preferable to carry out at 140 to 160° C. for 10 minutes to 3 hours. The fatty acid anhydride used in the acylation is preferably, in view of price and handleability, acetic anhydride, propionic anhydride, butyric anhydride, isobutyric anhydride or a mixture of 2 or more selected from these anhydrides, with acetic anhydride being more preferable.

The polymerization subsequent to the acylation is preferably carried out at 130 to 400° C. while the temperature is raised at a rate of 0.1 to 50° C/minute, and more preferably carried out at 150 to 350° C. while the temperature is raised at a rate of 0.3 to 5° C./minute. Further, in the polymerization, the acyl group in an acylated product is preferably 0.8 to 1.2 times by mole of the carboxyl group.

During the acylation and/or the polymerization, it is preferable to remove by-product fatty acid and unreacted fatty acid anhydride from the system by evaporation or the like to move the equilibrium.

The acylation and the polymerization may be carried out in the presence of a catalyst. Known polymerization catalysts for the polyester production can be used as the catalyst, and examples include metal compound catalysts such as magnesium acetate, tin (II) acetate, tetrabutyl titanate, lead acetate, sodium acetate, potassium acetate and antimony trioxide, and organic compound catalysts such as N,N-dimethylaminopyridine and N-methylimidazole. Among these catalysts, heterocyclic compounds containing two or more nitrogen atoms such as N,N-dimethylaminopyridine, N-methylimidazole, etc., are preferably used (see, e.g., Japanese Patent Application Laid-Open No. 2002-146003). The catalyst is usually added together when a monomer is added, and, in the case wherein the catalyst is not removed after the acylation, the polymerization can proceed directly after the acylation.

The liquid crystalline polyester obtained by such a polymerization can be used in the present invention directly, but, for further improvement in heat resistance and liquid crystalline properties, it is preferable to make the polyester higher molecular weight by solid phase polymerization. The solid phase polymerization can be preferably carried out by crushing the comparative low molecular weight liquid crystalline polyester obtained by the above polymerization into a powder or flake state, and, for example, heat treating the crushed liquid crystalline polyester in a solid phase state in an atmosphere of an inert gas such as nitrogen at 20 to 350° C. for 1 to 30 hours. The solid phase polymerization may be carried out with stirring or in a standing state without stirring. To obtain the liquid crystalline polyester having a suitable flow initiation temperature to be described below, the solid phase polymerization temperature is preferably 210° C. or higher and more preferably 220° C. to 350° C. and the solid phase polymerization time is preferably 1 to 10 hours.

The liquid crystalline polyester has a flow initiation temperature of preferably 250° C. or higher, more preferably 250° C. to 300° C., and further preferably 260° C. to 290° C. The higher the flow initiation temperature of the liquid crystalline polyester is, the adherence between the obtained liquid crystalline polyester impregnated fiber sheet and the conductor layer tends to be improved, whereas when the temperature is too high, the solubility of the liquid crystalline polyester in a solvent is reduced and the viscosity of the obtained liquid composition is increased making it difficult to handle.

The flow initiation temperature as referred to herein means a temperature at which the melt viscosity of the liquid crystalline polyester is 4800 Pa·s or lower at a pressure of 9.8 MPa in terms of the melt viscosity evaluation by a flow tester. The flow initiation temperature is known by those skilled in the art as a measure of the molecular weight of liquid crystalline polyesters (“Ekisho porima—gosei, seikei, oyou (in Japanese)” (“Liquid Crystal Polymer—Synthesis, Molding, Application”) edited by Naoyuki Koide, pp 95-105, CMC, published on Jun. 5, 1987).

The liquid crystalline polyester impregnated fiber sheet is produced by dissolving the liquid crystalline polyester described as above in a solvent, dissolving or dispersing other ingredients as necessary in the solvent and impregnating a fiber sheet with the thus obtained liquid composition, followed by removing the solvent. During the production, an aprotic solvent free of a halogen atom is used as the solvent and a sheet composed of an aramid fiber or a polybenzazole fiber is used as the fiber sheet. This enables to produce the liquid crystalline polyester impregnated fiber sheet having good dimensional stability, specifically, having a low coefficient of linear expansion in the direction parallel to the surface during heating. Further, the thus obtained liquid crystalline polyester impregnated fiber sheet is imparted with high heat resistance, low dielectric loss properties, low water absorbency which are inherent in liquid crystalline polyesters. Furthermore, by using an aprotic solvent free of a halogen atom as the solvent, a liquid composition having low corrosiveness and being easy to handle can be obtained, making it possible to produce the liquid crystalline polyester impregnated fiber sheet in an easily operable manner.

The aprotic solvent free of a halogen atom in which the liquid crystalline polyester used can be dissolved, specifically those wherein the liquid crystalline polyester can be dissolved at 50° C. at a density of 1% by mass or higher ([liquid crystalline polyester]/[liquid crystalline polyester+solvent]) is used as a mixed solvent of 2 or more as necessary. Further, a solvent having a boiling point of 180° C. or lower at one atmospheric pressure is preferably used because it is easily removed after the fiber sheet is impregnated with the liquid composition. In some cases, the aprotic solvent free of a halogen atom and solvents other than this solvent may be used together, but the amount of the latter solvent used is usually 10% by mass or lower based on the amount of the former used.

Examples of the aprotic solvent free of a halogen atom include ether solvents such as diethyl ether, tetrahydrofuran and 1,4-dioxane; ketone solvents such as acetone and cyclohexanone; ester solvents such as ethyl acetate; lactone solvents such as γ-butyrolactone; carbonate solvents such as ethylene carbonate and propylene carbonate; amine solvents such as triethylamine and pyridine; nitrile solvents such as acetonitrile and succinonitrile; amide solvents such as N,N-dimethylformamide, N,N-dimethylacetamide, tetramethylurea and N-methylpyrrolidone; nitro solvents such as nitromethane and nitrobenzene; sulfur solvents such as dimethyl sulfoxide and sulfolane; phosphorus solvents such as hexamethylphosphoramide and tri n-butyl; and two or more of these may be used in mixture as necessary.

Among these, due to easy dissolution of the liquid crystalline polyester, a polar solvent having a dipole moment of 3 to 5 is preferable, amide solvents and lactone solvents are more preferable, and N,N-dimethylformamide, N,N-dimethylacetamide, and N-methylpyrrolidone are further preferable.

It is preferable for the content of the liquid crystalline polyester in the liquid composition to be 20 to 50 parts by mass, it is more preferable for the content to be 22 to 40 parts by mass, based on 100 parts by mass of the content of the aprotic solvent free of a halogen atom. The larger the content of the liquid crystalline polyester in the liquid composition is, there is a tendency that nonuniform thickness of the obtained liquid crystalline polyester impregnated fiber sheet is unlikely to occur, whereas the smaller the content of the liquid crystalline polyester in the liquid composition is, there is a tendency that the viscosity of the liquid composition is reduced and the liquid composition is easily impregnated into the fiber sheet.

The liquid composition may contain as necessary one or more resins other than the liquid crystalline polyester, for example, thermoplastic resins such as polypropylene, polyamide, polyester, polyphenylene sulfide, polyether ketone, polycarbonate, polyether sulfone, polyphenyl ether and modified products thereof and polyetherimide; elastomers such as copolymer of glycidyl methacrylate and polyethylene; thermosetting resins such as phenol resin, epoxy resin, polyimide resin and cyanate resins. In this case, it is preferable that these other resins be also dissolved in the solvent.

Further, for the purpose of improving the dimensional stability, thermal conductivity, electrical properties, and the like, for example, one or two or more of inorganic fillers such as silica, alumina, titanium oxide, barium titanate, strontium titanate, aluminum hydroxide and calcium carbonate; organic fillers such as a cured epoxy resin, a crosslinked benzoguanamine resin and a crosslinked acrylic polymer; and various additives such as an antioxidant and an ultraviolet absorber may also be contained in the liquid composition.

As an aramid fiber composing the fiber sheet, paraoriented aromatic polyamide fiber and paraoriented aromatic polyamide hydrazine fiber are preferable, and examples include fibers composed of poly(paraamino benzamide), poly(paraamino benzhydrazide terephthalamide), poly(terephthalic acid hydrazide), poly(paraphenylene terephthalamide), copolyparaphenylene-3,4′-oxydiphenylene-terephthalamide and copolymers thereof. Further, examples of commercial aramid fiber include DuPont “Kevlar” and Teijin Techno Products Ltd. “Technora” and “Conex”.

Examples of the polybenzazole (PBZ) fiber composing the fiber sheet include polybenzoxazole (PBO) homopolymer, polybenzothiazole (PBT) homopolymer and fibers composed of random, sequenced or block copolymer of PBO and PBT. Further, an example of commercial polybenzazole fiber includes TOYOBO CO., LTD., “ZYLON”.

It is preferable, from the viewpoint of enhancing the strength of the fiber sheet, for the fiber diameter of the aramid fiber or the polybenzazole fiber to be 3 μm or more, it is more preferable for the diameter to be 5 μm or more, and, from the viewpoint of thinning the fiber sheet, it is preferable for the diameter to be 20 μm or less, it is more preferable to be 16 μm or less. In addition, it is preferable that the aramid fiber or the polybenzazole fiber (monofilament) in the form of fiber bundle (multifilament) have an elastic modulus of 70 to 300 GPa, have no strand and compose high intensity organic fiber multifilament having a negative coefficient of thermal expansion.

The fiber sheet may be textile (woven fabric), knitted fabric or non-woven fabric, but it is preferable that the fiber sheet be textile from the viewpoint of enhancing the dimensional stability of the obtained liquid crystalline polyester impregnated fiber sheet.

Examples of the weaving structure of the textile include plain weave structure, double weave structure composed of front and rear woven foundation, satin weave structure, twill weave structure and harness twill weave structure, with plain weave structure being preferable. Further, examples of the loom for producing textiles include jet looms such as air jet loom and water jet loom and rapier looms.

The fiber sheet may be subjected to press processing for thinning. Examples of the press processing include processing by the pressure of water stream, processing by high frequency vibration using liquid as a medium, processing using the pressure of a fluid having a surface pressure and processing carried out by pressure applied using a heat roll. Among these, it is preferable to carry out heat press processing wherein a pressure is applied using a heat roll, and it is more preferable to carry out the heat press processing using a heat roll after performing the processing by a water stream pressure or the processing using the pressure of a fluid having a surface pressure.

When processing by a pressure applied using a heat roll, it is preferable that the heat roll temperature be a temperature which can cause plastic deformation to the whole or a part of the aramid fiber or the polybenzazole fiber (monofilament) and make the fiber bundle (multifilament) flat and not melt, degrade or carbonize the aramid fiber or the polybenzazole fiber, and the temperature is suitably determined according to the type of aramid fiber or polybenzazole fiber and it is preferable to be 100 to 500° C., more preferable to be 300 to 400° C. Further, the pressure applied by a heat roll is preferably 800 to 5000 N/cm.

It is preferable that the press processing be carried out in a state wherein the tension applied to the fiber sheet is as low as possible, and the tension is preferably 10 to 300 N/m, more preferably 10 too 100 N/m.

The press-processed fiber sheet is, for example, surface-treated using a silane coupling agent to enhance the adhesive properties between the liquid crystalline polyester and the fiber sheet.

The thickness of the thus obtained fiber sheet is preferably 10 to 100 μm, more preferably 10 to 90 μm, further preferably 10 to 70 μm.

The impregnation of the liquid composition into the fiber sheet is typically carried out by immersing the fiber sheet in a dip tank in which the liquid composition is charged. At this step, the amount of the liquid crystalline polyester to be impregnated into the fiber sheet can be adjusted by suitably changing, according to the content of the liquid crystalline polyester in the liquid composition, the immersion time of the fiber sheet and the pull up speed of the liquid composition impregnated fiber sheet from a dip tank. The impregnation amount of the liquid crystalline polyester is preferably 30 to 80% by mass, more preferably 40 to 70% by mass, based on the total mass of the obtained liquid crystalline polyester impregnated fiber sheet.

Subsequently, the liquid crystalline polyester impregnated fiber sheet can be obtained by removing the solvent in the liquid composition from the liquid composition impregnated fiber sheet. It is preferable that the removal of the solvent be carried out by the evaporation of the solvent due to the simple operation, and examples of such a method include heating, pressure reduction, air ventilation and methods of combination thereof.

After removing the solvent, further heat treatment may be carried out whereby the liquid crystalline polyester can be made even higher molecular weight. The heat treatment is carried out, for example, in an atmosphere of an inert gas such as nitrogen at 240 to 330° C. for 1 to 30 hours. To enhance the heat resistance of the liquid crystalline polyester impregnated fiber sheet, it is preferable that the heat treatment temperature be 250° C. or higher, it is more preferable to be 260 to 320° C. Further, the heat treatment time is typically 1 to 60 hours from the viewpoint of the productivity.

A conductive layer attached liquid crystalline polyester impregnated fiber sheet is obtained by laminating a plurality of the thus obtained liquid crystalline polyester impregnated fiber sheets as necessary, followed by forming a conductor layer on at least one of the surfaces.

The formation of a conductor layer may be carried out by laminating a metal foil, for example by adhesion using an adhesive or by heat press fusion, or may be carried out by coating metal particles using a plating method, a screen printing method, a sputtering method and the like. The metal composing metal foil or metal particle includes, for example, copper, aluminum and silver, but, from the viewpoint of conductivity and cost, copper is preferably used.

The thus obtained conductive layer attached liquid crystalline polyester impregnated fiber sheet can be suitably used as a printed circuit board having the liquid crystalline polyester impregnated fiber sheet as an insulating layer by forming a predetermined circuit pattern on the conductor layer and laminating a plurality of sheets as necessary.

### <EXAMPLE>

### Example 1

### (1) Production of Aromatic Liquid Crystalline Polyester

1976 g (10.5 mol) of 2-hydroxy-6-naphthoic acid, 1474 g (9.75 mol) of 4-hydroxyacetanilide, 1620 g (9.75 mol) of isophthalic acid and 2374 g (23.25 mol) of acetic anhydride were loaded in a reactor equipped with a stirrer, a torque meter, a nitrogen gas induction pipe, a thermometer and a reflux condenser, the inside of the reactor was thoroughly replaced with nitrogen gas, the temperature was raised to 150° C. over the time of 15 minutes in a nitrogen gas stream and the mixture was refluxed for 3 hours at the maintained temperature. Subsequently, while removing distilled by-product acetic acid and unreacted acetic anhydride, the temperature was raised to 300° C. over the time of 170 minutes, the contents were taken out at the time of detecting the increase of the torque, the temperature was cooled to room temperature and the contents taken out were crushed in a coarse grinder to obtain a liquid crystalline polyester powder. The liquid crystalline polyester powder was measured for the flow initiation temperature using a flow tester (Shimadzu Corporation, “CFT-500 model”) and found to have a temperature of 235° C. Subsequently, the liquid crystalline polyester powder was heat treated at 223° C. for 3 hours in a nitrogen atmosphere to carry out solid phase polymerization. The flow initiation temperature of the liquid crystalline polyester powder after the solid phase polymerization was 270° C.

### (2) Preparation of Liquid Composition

2200 g of the solid-phase polymerized liquid crystalline polyester powder obtained in the above (1) was added to 7800 g of N,N-dimethylacetamide, heated at 100° C. for 2 hours and dissolved to obtain a liquid composition (an N,N-dimethylacetamide solution of the liquid crystalline polyester). The viscosity of this liquid composition was measured at 23° C. using a B type viscometer (Toki Sangyo Co., Ltd., “TVL-20 model”, rotor No. 21, rotation speed 5 rpm) and found to have a viscosity of 200 cP.

### (3) Production of Liquid Crystalline Polyester Impregnated Fiber Sheet

After immersing a fiber sheet (Asahi Kasei E-materials Corp, “086T”, thickness 0.060 mm, weight 35.2 g/m²) which was a textile composed of an aramid fiber (TEIJIN TECHNO PRODUCTS LIMITED, “Technora”, fiber diameter 12 μm) in the liquid composition obtained in the above (2) at 40° C. for 1 minute, the solvent was evaporated at 100° C. using a hot air dryer and the sheet was heat treated at 290° C. for 3 hours in a nitrogen atmosphere using a hot air dryer to obtain a liquid crystalline polyester impregnated fiber sheet (liquid crystalline polyester impregnation amount 45% by mass).

### (4) Production of Conductive Layer Attached Liquid Crystalline Polyester Impregnated Fiber Sheet

Four liquid crystalline polyester impregnated fiber sheets (10 cm square) obtained in the above (3) were superposed to each other, both surfaces thereof were sandwiched with copper foils (MITSUI MINING & SMELTING CO., LTD., “3EC-VLP”, thickness 18 μm) and heat pressed to integrate for 30 minutes under the conditions of 340° C. and a pressure of 5 MPa using a high temperature vacuum press (Kitagawa Seiki Co., Ltd., “KVHC-PRESS”), whereby a conductive layer attached liquid crystalline polyester impregnated fiber sheet was obtained.

### (5) Evaluation of Moisture Absorption Heat Resistance

The conductor layer (copper foil) was removed by etching from the conductive layer attached liquid crystalline polyester impregnated fiber sheet obtained in the above (4) using a ferric chloride aqueous solution (KIDA CO., LTD., 40° baume) to cut out a 5 cm square substrate for evaluation. The substrate for evaluation was treated for 24 hours at 23° C/relative humidity 50% and immersed in a solder bath at 260° C. for 30 seconds. The section of the evaluation substrate after the immersion was observed using a digital microscope (KEYENCE CORPORATION, “VH-8000”) to detect any peel between the liquid crystalline polyester and the fiber sheet, and the result is shown in Table 1.

### (6) Measurement of Coefficient of Linear Expansion

A 5 mm×20 mm sample for measurement was cut out from the 5 cm square substrate for evaluation obtained in the above (5) and, using a thermo mechanical analyzer (Seiko Instruments Inc., “TMA-120 model”) under ambient atmosphere while applying a load of 10 g, a temperature was raised from 30 to 250° C. at a heating rate of 5° C./min (temperature rising step 1), cooled down from 250 to 30° C. at a rate of 30° C./min, subsequently raised from 30 to 250° C. at a heating rate of 5° C./min (temperature rising step 2) during which a coefficient of linear expansion (ppm/° C.) in an MD direction (immersion direction) parallel to the surface from 50° C. to 100° C. was determined, and the results are shown in Table 1.

As for the fiber constituting the aramid fiber used in (3) above (a multifilament consisting of 48 monofilaments), the coefficient of linear expansion in longitudial direction was determined by the same method as the above method, except that a 20 mm-long sample for measurement was cut out and the 20 mm-long sample for measurement was used instead of the 5 mm×20 mm sample for measurement. As a result, the coefficient of linear expansion was −4.3 ppm/° C. (the minus value of coefficient of linear expansion means that the fiber shrinks by heat).

### Example 2

The same procedure as in Example 1 was carried out except that, in place of the fiber sheet which was a textile composed of the aramid fiber, a fiber sheet (Asahi Kasei E-materials Corp, “116Z”, thickness 0.065 mm, weight 44.5 g/m²) which was a textile composed of a polybenzoxazole fiber (TOYOBO, CO., LTD., “ZYLON”, fiber diameter 12 μm) was used, and the results are shown in Table 1.

As for the fiber constituting the polybenzoxazole fiber used above (a multifilament consisting of 66 monofilaments), a 20 mm-long sample for measurement was cut out and the coefficient of linear expansion in longitudial direction was determined by the same method as the above method. As a result, the coefficient of linear expansion was −5.9 ppm/° C.

### Comparative Example 1

The same procedure as in Example A1 was carried out except that, in place of the fiber sheet which was a textile composed of the aramid fiber, a fiber sheet (Asahi Kasei E-materials Corp., “116V”, thickness 0.073 mm, weight 37.0 g/m²) which was a textile composed of a liquid crystalline polyester fiber (KURARAY CO., LTD., “Vectran”, fiber diameter 16 μm) was used, and the results are shown in Table 1.

As for the fiber constituting the liquid crystalline polyester fiber used above (a multifilament consisting of 40 monofilaments), a 20 mm-long sample for measurement was cut out and the coefficient of linear expansion in longitudial direction was determined by the same method as the above method. As a result, the coefficient of linear expansion was −3.0 ppm/° C.

### Comparative Example 2

The same procedure as in Example A1 was carried out except that, in place of the fiber sheet which was a textile composed of the aramid fiber, a fiber sheet (Arisawa Manufacturing Co., Ltd., glass cloth, IPC naming 1078, thickness 0.045 mm, weight 47.0 g/m²) which was a textile composed of a glass fiber (fiber diameter 5 μm) was used, and the results are shown in Table 1.

As for the fiber constituting the glass fiber used above (a multifilament consisting of 200 monofilaments), a 20 mm-long sample for measurement was cut out and the coefficient of linear expansion in longitudial direction was determined by the same method as the above method. As a result, the coefficient of linear expansion was 4.5 ppm/° C.

TABLE 1

| | | heat resistance | Coefficient of |
|---|---|---|---|
| | | after moisture | linear expansion |
| Example | Fiber | absorption | (ppm/° C.) |
| Example 1 | Aramid | No peel | 2.0 |
| Example 2 | Polybenzoxazole | No peel | 4.9 |
| Comparative | Liquid crystalline | No peel | 21 |
| Example 1 | polyester | | |
| Comparative | Glass | No peel | 14 |
| Example 2 | | | |

What is claimed is:

1. A method for producing a liquid crystalline polyester impregnated fiber sheet, comprising:
a step of impregnating a fiber sheet composed of an aramid fiber or a polybenzazole fiber with a liquid composition containing a liquid crystalline polyester and an aprotic solvent free of a halogen atom; and
a step of removing the solvent from the fiber sheet impregnated with the liquid composition.

2. The method according to claim 1, wherein the liquid crystalline polyester is a liquid crystalline polyester having a structural unit represented by formula (1), a structural unit represented by formula (2) and a structural unit represented by formula (3)
(1) —O-Ar¹-CO—
(2) —CO-Ar²-CO—
(3) —X-Ar³-Y—wherein Ar¹ represents a phenylene group or a naphthylene group, Ar² represents a phenylene group, a naphthylene group or a group represented by formula (4), Ar³ represents a phenylene group or a group represented by formula (4), X and Y, each independently, represent O or NH, and
hydrogen atom(s) in the group represented by Ar¹, Ar² or Ar³, each independently, are optionally substituted with a halogen atom, an alkyl group or an aryl group
(4) —Ar⁴-Z-Ar⁵—wherein Ar⁴ and Ar⁵, each independently, represent a phenylene group or a naphthylene group, and Z represents O, CO or SO₂.

3. The method according to claim 2, wherein the liquid crystalline polyester has 30 to 60 mol% of the structural unit represented by the formula (1), 20 to 35 mol% of the structural unit represented by the formula (2) and 20 to 35 mol% of the structural unit represented by the formula (3), based on the total amount of all structural units.

4. The method according to claim 2, wherein X and/or Y is NH.

5. The method according to claim 2, wherein Ar¹ is a 1,4-phenylene group or a 2,6-naphthylene group, Ar² is a 1,4-phenylene group, a 1,3-phenylene group or a 2,6-naphthylene group, Ar³ is a 1,4-phenylene group, X is O, and Y is NH.

6. The method according to claim 1, wherein the solvent is at least one selected from the group consisting of N,N-dimethylformamide, N,N-dimethylacetamide and N-methylpyrrolidone.

7. The method according to claim 1, wherein a content of the liquid crystalline polyester in the liquid composition is 20 to 50 parts by mass based on 100 parts by mass of the solvent content.

8. The method according to claim 1, wherein the sheet is a textile.

9. The method according to claim 1, wherein a fiber diameter of the aramid fiber or the polybenzazole fiber is 3 to 20 μm.

10. A method for producing a conductive layer attached liquid crystalline polyester impregnated fiber sheet, comprising:
a step of obtaining a liquid crystalline polyester impregnated fiber sheet by the method according to claim 1; and
a step of forming a conductor layer on at least one of surfaces of the liquid crystalline polyester impregnated fiber sheet.
